(19) United States
(12) Patent Application Publication
(10) Pub. No.: US 2010/0124627 A1
(43) Pub. Date: May 20, 2010

(54) DOUBLE-COATED PRESSURE SENSITIVE ADHESIVE SHEET FOR FIXING HARD DISK DRIVE COMPONENT AND HARD DISK DRIVE

(75) Inventors: Takahiro Nonaka, Osaka (JP); Noritsugu Daigaku, Osaka (JP); Masahiro Ooura, Osaka (JP)

Correspondence Address: EDWARDS ANGELL PALMER & DODGE LLP, P.O. BOX 55874, BOSTON, MA, 02205, US

(73) Assignee: Nitto Denko Corporation, Osaka (JP)

(21) Appl. No.: 12/452,734

(22) PCT Filed: Aug. 20, 2008
(86) PCT No.: PCT/JP2008/064842

§ 371 Date: Jan. 20, 2010

(30) Foreign Application Priority Data
Aug. 24, 2007 (JP) 2007 218430

(51) Int. Cl. C09J 7/02; B32B 33/00

(52) U.S. Cl. 428/41.8

(57) ABSTRACT

Disclosed is a double-coated pressure-sensitive adhesive sheet adopted to fix a hard disk drive component, which includes a pressure-sensitive adhesive unit including a plastic film base having a thickness of 20 μm or less and pressure-sensitive adhesive layers arranged on or above both sides of the plastic film base; and non-silicone release liners arranged on both surfaces of the pressure-sensitive adhesive unit. The pressure-sensitive adhesive unit has a thickness of 60 μm or less, and the double-coated pressure-sensitive adhesive sheet shows an outgassing of 1 μg/cm² or less when the double-coated pressure-sensitive adhesive sheet is heated at a temperature of 120° C. for 10 minutes. The double-coated pressure-sensitive adhesive sheet is free from silicone, thereby causes less contamination, evolves less outgas, and is superior in workability. It has further improved followability to difference in level by controlling the thickness of the plastic film base to 13 μm or less. Additionally, it becomes resistant to “lifting” from an adherend even when subjected to a heating process after affixation, by specifying the gel fraction of the pressure-sensitive adhesive layer within a range of 10% to 60%.

### TECHNICAL FIELD

The present invention relates to double-coated pressure-sensitive adhesive sheets adopted to fix components of hard disk drives. It also relates to hard disk drives using the double-coated pressure-sensitive adhesive sheets.

### BACKGROUND ART

Double-coated pressure-sensitive adhesive sheets (double-sided tacky adhesive sheets) are currently generally used for the fixation of components such as flexible printed circuit boards (hereinafter also referred to as “FPC”s) in the fabrication of hard disk drives (magnetic recording systems; HDDs).

Exemplary known double-coated pressure-sensitive adhesive sheets include a double-coated pressure-sensitive adhesive sheet whose release liner has improved workability (processability), causes less contamination, and induces less outgassing (see Patent Document 1); and a double-coated pressure-sensitive adhesive sheet which has improved thermal stability and processing suitability (see Patent Document 2).

[Patent Document 1] Japanese Patent No. 3901490

[Patent Document 2] Japanese Unexamined Patent Application Publication (JP-A) No. 2006-89564

### DISCLOSURE OF INVENTION

### Problems to be Solved by the Invention

However, the following issues have been found. Even the double-coated pressure-sensitive adhesive sheets show insufficient workability, if designed to have a so-called “base-less” structure using no base or support. On the other hand, when double-coated pressure-sensitive adhesive sheets are designed to have a base-containing structure including a plastic film base and a pressure-sensitive adhesive layer arranged thereon so as to improve the workability, and if used for fixing a FPC, they may suffer typically from “lifting (insufficient adhesion)” of the FPC from a substrate due to heat applied typically in a sealing process after the fixation of FPC, in which such lifting occurs typically at a portion with “difference in level” (step) in interconnections. Additionally, such double-coated pressure-sensitive adhesive sheets may be applied to an adherend which bears a fine pattern, such as a circuit pattern, and thereby has fine steps (fine difference in level) on its surface. In this case, the pressure-sensitive adhesive layer may not sufficiently follow and come into a narrow space between the pattern (traces), to thereby cause a failure in followability to difference in level, in which a gap occurs between the adherend and the pressure-sensitive adhesive layer. This may occur particularly when pressing is undesirable or difficult to carry out upon the affixation of the double-coated pressure-sensitive adhesive sheets. Specifically, there has been obtained no double-coated pressure-sensitive adhesive sheet that satisfies the requirements for satisfactory workability, less contamination, and less outgassing. In addition, there has been obtained no double-coated pressure-sensitive adhesive sheet that satisfies, in addition to the above requirements, requirements for satisfactory followability to difference in level upon affixation and less “lifting” after the affixation.

Accordingly, an object of the present invention is to provide a double-coated pressure-sensitive adhesive sheet adopted to fix a hard disk drive component, which is free from silicone, thereby causes less contamination and less outgassing, and additionally shows superior workability. Another object of the present invention is to provide a double-coated pressure-sensitive adhesive sheet adopted to fix a hard disk drive component, which has, in addition to the above characteristic properties, such properties as to avoid “lifting” from an adherend upon processing after affixation of the sheet. Yet another object of the present invention is to provide a double-coated pressure-sensitive adhesive sheet adopted to fix a hard disk drive component, which is additionally superior in followability to difference in level. Still another object of the present invention is to provide a hard disk drive using any of the double-coated pressure-sensitive adhesive sheets.

### Means for Solving the Problems

After intensive investigations to achieve the objects, the present inventors have found that a double-coated pressure-sensitive adhesive sheet which is superior in all properties such as satisfactory workability, less contamination, and less outgassing can be obtained by constructing a pressure-sensitive adhesive sheet which has a specific thickness, uses a specific release liner, and uses a plastic film base with a specified thickness. They further have found that a double-coated pressure-sensitive adhesive sheet that is additionally superior in followability to difference in level can be obtained by further specifying the thickness of the plastic film base. Additionally, they have found that a double-coated pressure-sensitive adhesive sheet that is highly resistant to “lifting” after the affixation can be obtained by controlling the gel fraction of the pressure-sensitive adhesive layer within a specific range. The present invention has been made based on these findings.

Specifically, the present invention provides a double-coated pressure-sensitive adhesive sheet adopted to fix a hard disk drive component, the adhesive sheet includes a pressure-sensitive adhesive unit including a plastic film base having a thickness of 20 μm or less and pressure-sensitive adhesive layers arranged on or above both sides of the plastic film base; and non-silicone release liners arranged on both surfaces of the pressure-sensitive adhesive unit, in which the pressure-sensitive adhesive unit has a thickness of 60 μm or less, and the double-coated pressure-sensitive adhesive sheet shows an outgassing of 1 μg/cm² or less when the double-coated pressure-sensitive adhesive sheet is heated at a temperature of 120° C. for 10 minutes.

In an embodiment of the double-coated pressure-sensitive adhesive sheet adopted to fix a hard disk drive component, the plastic film base has a thickness of 13 μm or less.

In another embodiment of the double-coated pressure-sensitive adhesive sheet adopted to fix a hard disk drive component, the pressure-sensitive adhesive layers each have a gel fraction of 10% to 60%.

In yet another embodiment of the double-coated pressure-sensitive adhesive sheet adopted to fix a hard disk drive component, the pressure-sensitive adhesive layers each contain an acrylic pressure-sensitive adhesive including an acrylic polymer and a crosslinking agent and containing substantially no tackifier resin.

In still another embodiment of the double-coated pressure-sensitive adhesive sheet adopted to fix a hard disk drive component, the acrylic pressure-sensitive adhesive contains 100 parts by weight of an acrylic polymer; 0.15 to 1 part by weight of an isocyanate crosslinking agent; and 0 to 0.05 part by weight of an epoxy crosslinking agent.

In another embodiment of the double-coated pressure-sensitive adhesive sheet adopted to fix a hard disk drive component, the non-silicone release liners are polyolefin release liners.

In another embodiment, the double-coated pressure-sensitive adhesive sheet is adopted to fix a flexible printed circuit board.

In another embodiment, there is provided a hard disk drive including a component as fixed using the double-coated pressure-sensitive adhesive sheet.

### ADVANTAGES

The double-coated pressure-sensitive adhesive sheet adopted to fix a hard disk drive component, according to the present invention, has the above configuration, thereby has good workability, and causes less contamination and less outgassing. The double-coated pressure-sensitive adhesive sheet may have improved followability to difference in level by further specifying the thickness of the plastic film base. It becomes more resistant to “lifting” from an adherend even during or after a heating process after affixation, by controlling the gel fraction of the pressure-sensitive adhesive layers within a specific range. These advantageous effects give hard disk drives with better productivity and better quality.

### BRIEF DESCRIPTION OF DRAWINGS

FIG. 1 is a schematic cross-sectional view illustrating a double-coated pressure-sensitive adhesive sheet according to the present invention.

FIG. 2 is an explanatory drawing (schematic cross-sectional view) illustrating a FPC with a multilayer structure used in evaluation of followability to difference in level.

FIG. 3 is an explanatory drawing (plan view when viewed from the film base layer side) illustrating how and where a double-coated pressure-sensitive adhesive sheet (test specimen) is affixed to the FPC used in evaluation of followability to difference in level.

### REFERENCE NUMERALS

1 double-coated pressure-sensitive adhesive sheet adopted to fix a hard disk component
2 pressure-sensitive adhesive unit
   21 plastic film base
   22 pressure-sensitive adhesive layer
3 release liner
4 film base layer (polyimide film)
5 adhesive layer (epoxy adhesive)
6 copper foil layer
7 cover lay adhesive layer (epoxy adhesive)
8 cover lay film layer (polyimide film)
9 FPC (adherend)
   9a portion where copper foil is arranged
   9b portion where no copper foil is arranged
10 double-coated pressure-sensitive adhesive sheet (Test Specimen)

### BEST MODES FOR CARRYING OUT THE INVENTION

Embodiments of the present invention will be illustrated in detail with reference to the attached drawings.

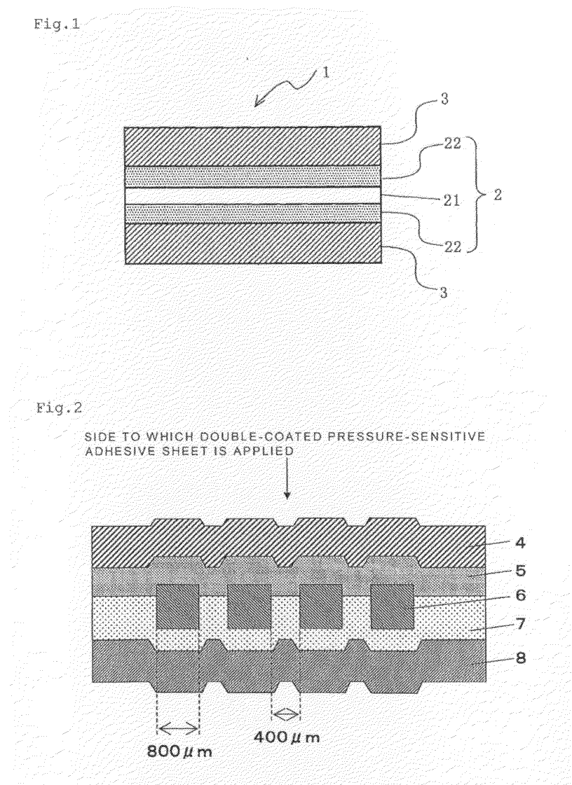

FIG. 1 is a schematic cross-sectional view illustrating an exemplary double-coated pressure-sensitive adhesive sheet adopted to fix a hard disk drive component, according to the present invention (hereinafter also simply referred to as a “double-coated pressure-sensitive adhesive sheet according to the present invention”). The double-coated pressure-sensitive adhesive sheet 1 according to the present invention includes a pressure-sensitive adhesive unit (portion other than release liners) 2 and release liners 3 arranged on or above both sides of the pressure-sensitive adhesive unit 2. The pressure-sensitive adhesive unit 2 includes a plastic film base 21, and pressure-sensitive adhesive layers 22 arranged on or above both sides of the plastic film base 21. As used herein a “double-coated pressure-sensitive adhesive sheet” additionally includes one in the form of a tape, i.e., a “double-coated pressure-sensitive adhesive tape”.

### [Pressure-Sensitive Adhesive Unit]

A pressure-sensitive adhesive unit for use in a double-coated pressure-sensitive adhesive sheet according to the present invention is composed of a plastic film base and, arranged on or above both sides thereof, pressure-sensitive adhesive layers, as illustrated above. The pressure-sensitive adhesive unit for use in the present invention may further include one or more of other layers, such as intermediate layers and undercoating layers, within ranges not adversely affecting the advantages of the present invention. The plastic film base and the pressure-sensitive adhesive layers may be laminated directly or with the interposition of another layer such as an intermediate layer.

The thickness of the pressure-sensitive adhesive unit is 60 μm or less, preferably 10 to 60 μm, more preferably 25 to 60 μm, and further preferably 40 to 60 μm. A pressure-sensitive adhesive unit having a thickness of greater than 60 μm may be disadvantageous upon reduction in thickness and size of a hard disk drive and may be liable to suffer from “lifting”. A pressure-sensitive adhesive unit having an excessively small thickness of smaller than 10 μm may show insufficient workability, handleability, and/or adhesiveness. As used herein the “thickness of the pressure-sensitive adhesive unit” refers to a thickness from one of adhesive faces (surface of one of the pressure-sensitive adhesive layers) to the other.

### (Plastic Film Base)

A plastic film base for use in the pressure-sensitive adhesive unit of the double-coated pressure-sensitive adhesive sheet according to the present invention is a support for the pressure-sensitive adhesive layers and plays a role of improving the workability and handleability (handling properties) of the double-coated pressure-sensitive adhesive sheet. The plastic film can be one generally used as a support of a pressure-sensitive adhesive sheet. Exemplary plastic films include resin films composed of resins such as polyester resins, olefin resins, poly(vinyl chloride) resins, acrylic resins, vinyl acetate resins, amide resins, polyimide resins, poly(ether ether ketone)s, and poly(phenylene sulfide)s. Among them, preferred are polyester films and polyolefin films, of which poly(ethylene terephthalate) (PET) films are more preferred from the viewpoints of cost and rigidity. The plastic film base for use herein may have a single-layer structure or multilayer structure.

The plastic film base may have been subjected to a common surface treatment to increase adhesion to the pressure-sensitive adhesive layers. Exemplary surface treatments include chromate treatment, exposure to ozone, exposure to a flame, exposure to a high-voltage electric shock, ionizing radiation treatment, and other chemical or physical oxidizing treatments. In addition or alternatively, the plastic film base may have been subjected to, for example, coating treatment with a primer.

The thickness of the plastic film base is 20 μm or less, preferably 16 μm or less (e.g., 2 to 16 μm), more preferably 13 μm or less (e.g., 2 to 13 μm), and further preferably 4 to 12 μm. A base (plastic film base) having a thickness of greater than 20 μm may have excessively high rigidity to often cause “lifting” after affixation, and/or may be disadvantageous for reduction in size and thickness of the hard disk drive. A base having an excessively small thickness may be difficult to be applied with a pressure-sensitive adhesive layer by direct application, or the resulting double-coated pressure-sensitive adhesive sheet may have insufficient handleability. Of the above-specified ranges, the plastic film base preferably has a thickness of 13 μm or less for improving the “followability to difference in level”. As used herein “followability to difference in level” (also referred to as “difference in level absorbing properties”) refers to such properties that a pressure-sensitive adhesive sheet, when affixed to an adherend, easily follows difference in level of the adherend. When such a double-coated pressure-sensitive adhesive sheet having good followability to difference in level is affixed typically to an adherend bearing a fine pattern (fine traces), the pressure-sensitive adhesive layer can follow and come into fine spaces between the traces, and the sheet more satisfactorily adheres to the adherend, even when the sheet is affixed to the adhered with a weak (small) pressing force. A double-coated pressure-sensitive adhesive sheet having a film base with a thickness of greater than 13 μm may suffer from a gap between an adherend and the pressure-sensitive adhesive layer when the sheet is affixed to an adherend bearing a fine pattern (fine traces) with a weak pressing force. The advantageous effects are obtained because the thickness of the pressure-sensitive adhesive layer is set to be relatively larger than that of the plastic film base.

### (Pressure-Sensitive Adhesive Layer)

A pressure-sensitive adhesive layer for use in the pressure-sensitive adhesive unit of the double-coated pressure-sensitive adhesive sheet according to the present invention is composed of an acrylic pressure-sensitive adhesive mainly containing an acrylic polymer. Such a pressure-sensitive adhesive may be prepared, for example, blending the acrylic polymer and one or more crosslinking agents with a variety of additives according to necessity. The content of the acrylic polymer as a main component is preferably 90 percent by weight or more, and more preferably 95 percent by weight or more, of the total weight of solid contents of the pressure-sensitive adhesive.

The acrylic polymer plays the role of exhibiting tackiness as a base polymer of the pressure-sensitive adhesive layer. Exemplary acrylic polymers usable herein include (meth)acrylic alkyl ester polymers which contain a (meth)acrylic alkyl ester (an acrylic alkyl ester and/or a methacrylic alkyl ester) as a main monomer component (main monomer) and which may further contain, where necessary, another ethylenically unsaturated monomer as a copolymerizable component (copolymerizable monomer). Each of different (meth)acrylic alkyl esters and each of different ethylenically unsaturated monomers may be used alone or in combination.

Exemplary (meth)acrylic alkyl esters for use as a main monomer component of the acrylic polymer include methyl (meth)acrylates, ethyl (meth)acrylates, propyl (meth)acrylates, isopropyl(meth)acrylates, n-butyl (meth)acrylates, isobutyl(meth)acrylates, sec-butyl (meth)acrylates, t-butyl (meth)acrylates, pentyl (meth)acrylates, isopentyl(meth)acrylates, neopentyl (meth)acrylates, hexyl(meth)acrylates, heptyl (meth)acrylates, octyl(meth)acrylates, isooctyl (meth)acrylates, 2-ethylhexyl(meth)acrylates, nonyl (meth)acrylates, isononyl(meth)acrylates, decyl (meth)acrylates, isodecyl(meth)acrylates, undecyl (meth)acrylates, dodecyl(meth)acrylates, tridecyl (meth)acrylates, tetradecyl(meth)acrylates, pentadecyl (meth)acrylates, hexadecyl(meth)acrylates, heptadecyl (meth)acrylates, octadecyl(meth)acrylates, nonadecyl (meth)acrylates, and icosyl(meth)acrylates. Among them, preferred are (meth)acrylic alkyl esters whose alkyl moiety has two to fourteen carbon atoms, such as ethyl (meth)acrylates, n-butyl (meth)acrylates, isobutyl (meth)acrylates, hexyl(meth)acrylates, 2-ethylhexyl (meth)acrylates, and dodecyl(meth)acrylates.

As used as a main monomer component, the amount of (meth)acrylic alkyl esters is 50 percent by weight or more (50 to 100 percent by weight), preferably 80 percent by weight or more, and further preferably 90 percent by weight or more of the total weight of monomer components. The amount of (meth)acrylic alkyl esters based on the total weight of monomer components is not particularly limited on its upper limit, but it is preferably 99 percent by weight or less, and further preferably 97 percent by weight or less. An acrylic polymer having a content of (meth)acrylic alkyl esters of less than 50 percent by weight of the total weight of monomer components may be less liable to exhibit characteristic properties as an acrylic polymer, such as tackiness.

The acrylic polymer may further contain, as a monomer component, a monomer component (copolymerizable monomer) that can undergo copolymerization with (meth)acrylic alkyl esters. Such a copolymerizable monomer can be used for introducing crosslinking points into the acrylic polymer and/or for controlling the cohesive force of the acrylic polymer. Each of different copolymerizable monomers may be used alone or in combination.

Exemplary copolymerizable monomers include carboxyl-containing monomers such as (meth)acrylic acids, itaconic acid, crotonic acid, maleic acid, fumaric acid, and isocrotonic acid, and acid anhydrides of them, such as maleic anhydride and itaconic anhydride; hydroxyl-containing monomers including hydroxyalkyl(meth)acrylates such as 2-hydroxyethyl (meth)acrylates, 2-hydroxypropyl (meth)acrylates, 2-hydroxybutyl (meth)acrylates, 4-hydroxybutyl (meth)acrylates, and 6-hydroxyhexyl (meth)acrylates, as well as vinyl alcohol and allyl alcohol; amide monomers such as (meth)acrylamides, N,N-dimethyl(meth)acrylamides, N-butyl(meth)acrylamides, N-methylol(meth)acrylamides, N-methylolpropane(meth)acrylamides, N-methoxymethyl(meth)acrylamides, and N-butoxymethyl(meth)acrylamides; amino-containing monomers such as aminoethyl (meth)acrylates, N,N-dimethylaminoethyl (meth)acrylates, and t-butylaminoethyl (meth)acrylates; epoxy-containing monomers such as glycidyl(meth)acrylates and methylglycidyl(meth)acrylates; cyano-containing monomers such as acrylonitrile and methacrylonitrile; and monomers having a nitrogen-containing ring, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth) acryloylmorpholine. Exemplary copolymerizable monomers further include vinyl ester monomers such as vinyl acetate and vinyl propionate; styrenic monomers such as styrene, substituted styrenes (e.g., α-methylstyrene), and vinyltoluene; olefinic monomers such as ethylene, propylene, isoprene, butadiene, and isobutylene; vinyl chloride, vinylidene chloride; isocyanate-containing monomers such as 2-(meth)acryloyloxyethyl isocyanate; alkoxy-containing monomers such as methoxyethyl (meth)acrylates and ethoxyethyl (meth)acrylates; vinyl ether monomers such as methyl vinyl ether and ethyl vinyl ether; as well as polyfunctional monomers such as 1,6-hexanediol di(meth)acrylates, butanediol di(meth)acrylates, ethylene glycol di(meth)acrylates, diethylene glycol di(meth)acrylates, triethylene glycol di(meth)acrylates, tetraethylene glycol di(meth)acrylates, (poly)ethylene glycol di(meth)acrylates, propylene glycol di(meth)acrylates, (poly)propylene glycol di(meth)acrylates, neopentyl glycol di(meth)acrylates, pentaerythritol di(meth)acrylates, trimethylolpropane tri(meth)acrylates, pentaerythritol tri(meth)acrylates, dipentaerythritol hexa(meth)acrylates, glycerol di(meth)acrylates, epoxy acrylates, polyester acrylates, urethane acrylates, and divinylbenzene. Among them, preferred copolymerizable monomers include (meth)acrylic acid, itaconic acid, maleic acid, hydroxyethyl (meth)acrylates, hydroxybutyl (meth)acrylates, and hydroxyhexyl (meth)acrylates.

The amount of copolymerizable monomers can be suitably selected according to the types of monomer components, within a range of less than 50 percent by weight of the total weight of monomer components. Merely by way of example, the amount of a carboxyl-containing monomer (typified by acrylic acid), if used as the copolymerizable monomer, is desirably 3 to 10 percent by weight, preferably 5 to 10 percent by weight, and further preferably 7 to 10 percent by weight, to 100 percent by weight of the total monomer components.

Such acrylic polymers can be prepared by polymerizing the monomer components according to a known or common polymerization technique. Exemplary polymerization techniques of acrylic polymers include solution polymerization, emulsion polymerization, mass polymerization (bulk polymerization), and polymerization through ultraviolet irradiation. Among them, solution polymerization is preferred from the viewpoints of cost and mass productivity. Upon polymerization of acrylic polymers, suitable components selected according to the polymerization technique from among known or common ones can be used. Such components include, for example, polymerization initiators, chain-transfer agents, emulsifiers, and solvents.

Azo initiators are preferred as polymerization initiators for use in polymerization of acrylic polymers through solution polymerization, of which more preferred are the azo initiators disclosed in Japanese Unexamined Patent Application Publication (JP-A) No. 2002-69411. Such azo initiators are preferred because their decomposed products are unlikely to remain as components causing outgassing (outgassing caused by heating) in the acrylic polymers. Exemplary azo initiators include 2,2′-azobisisobutyronitrile (hereinafter referred to as AIBN), 2,2′-azobis-2-methylbutyronitrile (hereinafter referred to as AMBN), dimethyl 2,2′-azobis(2-methylpropionate), and 4,4′-azobis-4-cyanovalerianic acid. The amount of azo initiators is 0.05 to 0.5 parts by weight, and preferably 0.1 to 0.3 parts by weight, to the total amount of monomer components (100 parts by weight).

Solvents for use in polymerization of acrylic polymers through solution polymerization can be, for example, known or common organic solvents. Exemplary organic solvents include ester solvents such as ethyl acetate and methyl acetate; ketone solvents such as acetone and methyl ethyl ketone; alcohol solvents such as methanol, ethanol, and butanol; hydrocarbon solvents such as cyclohexane, hexane, and heptane; and aromatic solvents such as toluene and xylenes. Each of different organic solvents may be used alone or in combination.

The weight-average molecular weight of acrylic polymers is preferably 30×10⁴ to 200×10⁴, more preferably 60×10⁴ to 150×10⁴, and further preferably 70×10⁴ to 150×10⁴. An acrylic polymer having a weight-average molecular weight of smaller than 30×10⁴ may not exhibit good adhesive properties; and in contrast, one having a weight-average molecular weight of greater than 200×10⁴ may cause insufficient coatability; thus being undesirable. The weight-average molecular weight can be controlled by the types and amounts of polymerization initiators, the temperature and duration of polymerization process, as well as the monomer concentration and the rate of dropwise addition of monomers.

Crosslinking agents for use in the acrylic pressure-sensitive adhesive play the roles of, for example, controlling the gel fraction (ratio of solvent-insoluble components) of the pressure-sensitive adhesive layer. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents are preferred as essential crosslinking agents, and, more preferably, such isocyanate crosslinking agents are used in combination with epoxy crosslinking agents. Each of different crosslinking agents may be used alone or in combination.

Exemplary isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, hydrogenated xylene diisocyanate, and hydrogenated xylylene diisocyanate; aromatic polyisocyanates such as 2,4-tolylene diisocyanate, 2,6-tolylene diisocyanate, 4,4′-diphenylmethane diisocyanate, and xylylene diisocyanate; as well as a trimethylolpropane/tolylene diisocyanate adduct [supplied by Nippon Polyurethane Industry Co., Ltd. under the trade name of “Coronate L”] and a trimethylolpropane/hexamethylene diisocyanate adduct [supplied by Nippon Polyurethane Industry Co., Ltd. under the trade name of “Coronate HL”].

Exemplary epoxy crosslinking agents include N,N,N′,N′-tetraglycidyl-m-xylenediamine, diglycidylaniline, 1,3-bis(N,N-glycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl) isocyanurate, resorcinol diglycidyl ether, and bisphenol-S-diglycidyl ether; as well as epoxy resins each having two or more epoxy groups per molecule.

The content of crosslinking agents in the pressure-sensitive adhesive is preferably 0.15 to 1.05 parts by weight, more preferably 0.2 to 1.05 parts by weight, and further preferably 0.2 to 0.5 part by weight, to 100 parts by weight of the acrylic polymer.

The content of isocyanate crosslinking agents, among these crosslinking agents, is preferably 0.15 to 1 part by weight, more preferably 0.2 to 1 part by weight, and further preferably 0.2 to 0.5 part by weight, to 100 parts by weight of the acrylic polymer. A pressure-sensitive adhesive layer having a content of isocyanate crosslinking agents of less than 0.15 part by weight may show insufficient anchoring properties to the adherend and thereby cause “lifting”; and one having a content of isocyanate crosslinking agents of greater than 1 part by weight may have an excessively high gel fraction and thereby have an excessively high repulsive force against bending, and the resulting adhesive sheet may be liable to suffer from “lifting”.

Isocyanate crosslinking agents, if contained in a relatively low content, may not sufficiently help to control the gel fraction, because most of isocyanate crosslinking agents undergo crosslinking by themselves. In this case, epoxy crosslinking agents are preferably used in combination. The content of epoxy crosslinking agents is preferably 0 to 0.05 part by weight, and more preferably 0 to 0.02 part by weight, to 100 parts by weight of the acrylic polymer. A pressure-sensitive adhesive layer having a content of epoxy crosslinking agents of greater than 0.05 part by weight may have an excessively high gel fraction and thereby have an excessively high repulsive force against bending, and the resulting adhesive sheet may be liable to suffer from “lifting”.

The acrylic pressure-sensitive adhesive may further contain, in addition to the components, known additives according to necessity within ranges not adversely affecting the characteristic properties. Exemplary additives include age inhibitors, fillers, colorants such as pigments and dyestuffs, ultraviolet-absorbers, antioxidants, plasticizers, softeners, surfactants, and antistatic agents.

The acrylic pressure-sensitive adhesive preferably contains substantially no tackifier resin. As used herein “contains substantially no” refers to that such tackifier resin is not positively incorporated, except for inevitable contamination. Specifically, the content of tackifier resins is preferably less than 1 percent by weight, and more preferably less than 0.1 percent by weight, based on the total weight of the acrylic pressure-sensitive adhesive (solid contents). An acrylic pressure-sensitive adhesive, if containing such tackifier resins, may cause outgassing when the pressure-sensitive adhesive layer is heated. Specific exemplary tackifier resins include rosin derivative resins, polyterpene resins, petroleum resins, and oil-soluble phenol resins.

A technique to form a pressure-sensitive adhesive layer (a technique to prepare a pressure-sensitive adhesive unit) of the double-coated pressure-sensitive adhesive sheet according to the present invention is not particularly limited and may be suitably selected from among known techniques for forming pressure-sensitive adhesive layers. Specifically but merely by way of example, the techniques include a direct application technique in which the pressure-sensitive adhesive (or a solution thereof) is applied to a predetermined surface (e.g., a surface of the base) to have a predetermined thickness after drying, and the applied film is dried or cured according to necessity; and a transfer technique in which the pressure-sensitive adhesive (or a solution thereof) is applied to a suitable release liner to have a predetermined thickness after drying, the applied film is dried or cured according to necessity to form a pressure-sensitive adhesive layer, and the pressure-sensitive adhesive layer is transferred onto a predetermined surface (e.g., a surface of the base). The application or coating of the pressure-sensitive adhesive (or pressure-sensitive adhesive solution) may be conducted using a common coater. Exemplary coaters include gravure roll coaters, reverse roll coaters, kiss-roll coaters, dip roll coaters, bar coaters, knife coaters, and spray coaters.

The thickness of each of the pressure-sensitive adhesive layers, as a layer on one side of the plastic film base, is not particularly limited but is preferably 4 to 29 μm, more preferably 10 to 25 μm, and further preferably 15 to 20 μm. A pressure-sensitive adhesive layer having a thickness of smaller than 4 μm may not sufficiently help to provide good adhesiveness. In contrast, a pressure-sensitive adhesive layer having a thickness of greater than 29 μm may invite an excessively large thickness of the double-coated pressure-sensitive adhesive sheet and may be disadvantageous for reduction in thickness and size of the hard disk drive. Each of the pressure-sensitive adhesive layers may have a single-layer structure or multilayer-structure.

The gel fraction of the pressure-sensitive adhesive layers is preferably 10% to 60% (percent by weight), more preferably 10% to 50%, and further preferably 15% to 50%. Controlling the gel fraction of the pressure-sensitive adhesive layers within the range makes the double-coated pressure-sensitive adhesive sheet to be resistant to “lifting” from an adherend, if it is affixed to the adherend and then subjected to a heating process. Pressure-sensitive adhesive layers having a gel fraction of smaller than 10% may have an insufficient cohesive force and become susceptible to a cohesive failure, and this may cause insufficient adhesiveness and reworkability (e.g., prevention of an adhesive transfer upon peeling), thus being undesirable. In contrast, pressure-sensitive adhesive layers having a gel fraction of greater than 60% may have excessively high repulsive force against bending, and this may often cause “lifting” typically at a portion with difference in level during or after a heating process, thus being undesirable. The gel fraction may be controlled, for example, by the monomer composition of the acrylic polymer, and the types and contents of crosslinking agents.

Specifically, the gel fraction (solvent-insoluble content) is determined, for example, according to the following “technique for measuring gel fraction”.

(Technique for Measuring Gel Fraction)

About 0.1 g of a pressure-sensitive adhesive is sampled from a pressure-sensitive adhesive layer, covered by a porous tetrafluoroethylene sheet (supplied by Nitto Denko Corporation under the trade name of “NTF 1122”) having an average pore size of 0.2 μm, tied with a kite string, the weight of the resulting article is measured, and this weight is defined as a “weight before immersion”. The “weight before immersion” is the total weight of the pressure-sensitive adhesive layer (pressure-sensitive adhesive), the tetrafluoroethylene sheet, and the kite string. Additionally, the total weight of the tetrafluoroethylene sheet and the kite string is measured as a tare weight.

Next, the pressure-sensitive adhesive layer (pressure-sensitive adhesive) covered by the tetrafluoroethylene sheet and tied with the kite stirring (hereinafter also referred to as “sample”) is placed in a 50-ml vessel filled with ethyl acetate, and left stand at room temperature for one week (7 days). The sample after immersion in ethyl acetate is retrieved from the vessel, transferred into an aluminum cup, dried in a drier at 130° C. for 2 hours to remove ethyl acetate, and the weight of the resulting sample is measured as a weight after immersion.

A gel fraction is then calculated according to the following equation:

Gel fraction (percent by weight)=(A−B)/(C−B)×100 (1)

wherein “A” represents the weight after immersion; “B” represents the tare weight; and “C” represents the weight before immersion.

### [Release Liner]

In a double-coated pressure-sensitive adhesive sheet according to the present invention, both sides (adhesive faces) of the pressure-sensitive adhesive unit are protected by release liners (separators). Such release liners for use herein are non-silicone release liners using no silicone release agent. If silicone release liners are used, silicone compounds attached to the adhesive faces or absorbed by the pressure-sensitive adhesive layers evolve siloxane gas and cause contamination of the adherend, and thereby cause corrosion or a contact fault of electronic components used in the hard disk drive. Non-silicone release liners do not cause these problems and are advantageously used herein.

The non-silicone release liners are not particularly limited, as long as they do not use silicone release agents. Exemplary non-silicone release liners include base materials having a release layer, low-adhesive base materials made typically of fluorine-containing polymers and low-adhesive base materials made of nonpolar polymers. Exemplary base materials having a release layer include a plastic film which has a surface treated with a release agent such as a long-chain alkyl release agent, a fluorine-containing release agent, or molybdenum sulfide, and a paper which has a surface treated with a release agent such as a long-chain alkyl release agent, a fluorine-containing release agent, or molybdenum sulfide. Exemplary fluorine-containing polymers include polytetrafluoroethylenes, polychlorotrifluoroethylenes, polyvinyl fluoride)s, poly(vinylidene fluoride)s, tetrafluoroethylene-hexafluoropropylene copolymers, and chlorofluoroethylene-vinylidene fluoride copolymers. Exemplary nonpolar polymers include olefin resins such as polyethylenes and polypropylenes. Among them, preferred are release liners having a releasable surface made of an olefin resin (polyolefin release liners), of which release liners having a releasable surface made of a polyethylene (polyethylene release liners) are more preferred. The polyolefin release liners have only to have a polyolefin resin layer to be in contact with an adhesive face, and may be, for example, a multilayer film of a polyester resin layer and a polyolefin resin layer.

In a double-coated pressure-sensitive adhesive sheet according to the present invention, it is preferred that a release force between the pressure-sensitive adhesive unit and one of the release liners differs from a release force between the pressure-sensitive adhesive unit and the other release liner, because this improves the workability. The release force between the pressure-sensitive adhesive unit and the release liner on a side with a smaller release force (more peelable side) (hereinafter referred to as “release force of the more peelable side”) is preferably 0.01 to 0.3 N/50 mm, more preferably 0.05 to 0.3 N/50 mm, and further preferably 0.1 to 0.3 N/50 mm. On the other hand, the release force between the pressure-sensitive adhesive unit and the release liner on a side with a greater release force (less peelable side) (hereinafter referred to as “release force of the less peelable side”) is preferably 0.1 to 2 N/50 mm, and more preferably 0.5 to 1 N/50 mm. The difference between the release force of the more peelable side and that of the less peelable side (difference in release force) is preferably 0.05 N/50 mm or more, and more preferably 0.1 to 1 N/50 mm. The difference in release force is represented by: [(release force of the less peelable side)-(release force of the more peelable side)]

Exemplary factors for controlling the release forces include surface roughness, the types of release agents, and conditions for heating process.

Exemplary preferred release liners for use herein as the more peelable side include polyolefin release liners having a release layer (releasable layer) made of a polyolefin resin and having a non-flat or uneven surface, such as the release liner described in Japanese Unexamined Patent Application Publication (JP-A) No. 2005-350650.

In contrast, exemplary preferred release liners for use herein as the less peelable side include polyolefin release liners having a release layer without such a non-flat surface, such as the release liner described in Japanese Patent No. 3901490.

### [Double-Coated Pressure-Sensitive Adhesive Sheet and Hard Disk Drive]

A double-coated pressure-sensitive adhesive sheet according to the present invention includes the release liners arranged on or above both sides (both adhesive faces) of the pressure-sensitive adhesive unit.

The double-coated pressure-sensitive adhesive sheet shows an outgassing (total outgassing: total amount of evolved outgas) evolved when heated at a temperature of 120° C. for 10 minutes of 1 μg/cm² or less, preferably 0.8 μg/cm² or less, and more preferably 0.4 μg/cm² or less, as determined according to the measuring technique as follows. Specifically, the amount of outgas (outgassing) of the double-coated pressure-sensitive adhesive sheet is determined in such a manner that the release liners are removed from the both sides of the double-coated pressure-sensitive adhesive sheet; a PET film as a backing is affixed to either one adhesive face; and the outgassing evolved from the other adhesive face bearing no PET film is measured. A double-coated pressure-sensitive adhesive sheet showing an outgassing of 1 μg/cm² or less does not cause corrosion and malfunction due to outgas components and is superior in long-term reliability even when it is used in a hard disk drive. These outgases are generally derived from silicone release agents in release liners and unreacted monomer components in pressure-sensitive adhesives. Thus, outgassing is reduced in the present invention by using non-silicone release liners. The outgassing can further be reduced typically by controlling the types of polymerization initiators for the acrylic polymer for use in the pressure-sensitive adhesive and molecular weights of the acrylic polymer for use in the pressure-sensitive adhesive within preferred ranges.

The double-coated pressure-sensitive adhesive sheets according to the present invention are adopted to fix components in fabrication of hard disk drives (for fixing hard disk drive components). Exemplary components include flexible printed circuit boards, metallic plates or sheets, resinous films, metal foils, multilayer films of a metal layer and a resinous film, labels, and motors. The double-coated pressure-sensitive adhesive sheets are preferably adopted to fix flexible printed circuit boards among these components, from the viewpoints of effectively reducing “lifting” even after undergoing processes such as baking for resin curing (conducted, for example, by heating at about 90° C.), in which the “lifting” occurs due typically to difference in level in conductors.

The flexible circuit boards may be composed of, but not limited to, an electrically insulating (dielectric) layer (hereinafter also referred to as “base dielectric layer”); an electroconductor layer arranged on the base dielectric layer so as to have a predetermined circuit pattern (hereinafter also referred to as “conductor layer”); and, where necessary, a dielectric layer for covering, arranged on the conductor layer (hereinafter also referred to as “covering dielectric layer”). The flexible circuit boards may also have a multilayer structure composed of two or more circuit boards as stacked.

The base dielectric layer is a dielectric layer made of an electrically insulating material. Electrically insulating materials for constituting the base dielectric layer are not particularly limited and can be selected suitably from among electrically insulating materials used in known flexible circuit boards. Specifically, exemplary preferred electrically insulating materials include plastic materials such as polyimide resins, acrylic resins, poly(ether nitrile) resins, poly(ether sulfone) resins, polyester resins (e.g., poly(ethylene terephthalate) resins and poly(ethylene naphthalate) resins), poly(vinyl chloride) resins, poly(phenylene sulfide) resins, poly(ether ether ketone) resins, polyamide resins (e.g., so-called “aramid resins”), polyarylate resins, polycarbonate resins, and liquid crystalline polymers. Each of different electrically insulating materials may be used alone or in combination. Among them, polyimide resins are preferred. The base dielectric layer may have a single-layer structure or a multilayer structure. The surface of the base dielectric layer may have been subjected to a variety of surface treatments such as corona discharge treatment, plasma treatment, surface roughening treatment, and hydrolysis treatment. The thickness of the base dielectric layer is not particularly limited but is preferably 3 to 100 μm, more preferably 5 to 50 μm, and further preferably 10 to 30 μm.

The conductor layer is an electroconductor layer made from an electroconductive material. The conductor layer is arranged on the base dielectric layer so as to have a predetermined circuit pattern. Electroconductive materials for constituting the conductor layer are not particularly limited and can be selected suitably from among electroconductive materials used in known flexible circuit boards. Specifically, exemplary preferred electroconductive materials include metallic materials such as copper, nickel, gold, and chromium, as well as various alloys, such as solders, and platinum; and electroconductive plastic materials. Each of different electroconductive materials may be used alone or in combination. Among them, metallic materials are preferred, of which copper is more preferred. The conductor layer may have a single-layer structure or a multilayer structure. The surface of the conductor layer may have been subjected to a variety of surface treatments. The thickness of the conductor layer is not particularly limited, but is preferably 1 to 50 μm, more preferably 2 to 30 μm, and further preferably 3 to 20 μm.

The technique to form the conductor layer is not particularly limited and can be suitably selected from among known techniques for forming conductive layers (known patterning processes such as subtractive process, additive process, and semi-additive process). By way of example, when a conductor layer is directly arranged on a surface of a base dielectric layer, the conductor layer may be formed typically by plating or vapor-depositing an electroconductive material onto the base dielectric layer so as to have a predetermined circuit pattern, through a process such as electroless plating, electrolytic plating, vacuum deposition, or sputtering.

The covering dielectric layer is a covering dielectric layer (protecting dielectric layer) that is made from an electrically insulating material and covers the conductor layer. The covering dielectric layer may be arranged according to necessity and need not be necessarily arranged. Electrically insulating materials for constituting the covering dielectric layer are not particularly limited and can be suitably selected from among electrically insulating materials used in known flexible circuit boards, as in the base dielectric layer. Specifically, exemplary electrically insulating materials for constituting the covering dielectric layer include those listed as the electrically insulating materials for constituting the base dielectric layer. Among them, plastic materials are preferred, of which polyimide resins are more preferred, as in the base dielectric layer. Each of different electrically insulating materials may be used alone or in combination for constituting the covering dielectric layer. The covering dielectric layer may have a single-layer structure or a multilayer structure. The surface of the covering dielectric layer may have been subjected to a variety of surface treatments such as corona discharge treatment, plasma treatment, surface roughening treatment, and hydrolysis treatment. The thickness of the covering dielectric layer is not particularly limited, but is preferably 3 to 100 μm, more preferably 5 to 50 μm, and further preferably 10 to 30 μm.

A technique to form the covering dielectric layer is not particularly limited and may be suitably selected from among known techniques for forming such covering dielectric layers. Exemplary techniques include a technique of applying a liquid or melt containing an electrically insulating material to the conductor layer and drying the applied layer; and a technique of laminating a film or sheet onto the conductor layer, which film or sheet has a shape corresponding to the shape of the conductor layer and is made from an electrically insulating material.

Hard disk drives can be fabricated by affixing components such as the flexible circuit boards typically to motors, bases, substrates, and covers using the double-coated pressure-sensitive adhesive sheets according to the present invention. Specifically, hard disk drives with superior reliability and high quality can be obtained by fabricating the hard disk drives through affixation of components using the double-coated pressure-sensitive adhesive sheets, because the resulting hard disk drives may be free from contamination derived from the pressure-sensitive adhesive sheets and may not suffer from lifting of FPCs.

### EXAMPLES

The present invention will be illustrated in further detail with reference to several examples below. It should be noted, however, these are illustrated only by way of example and never construed to limit the scope of the present invention.

### Example 1

A solution (solids concentration of 25 percent by weight) of an acrylic polymer having a weight-average molecular weight of 150×10⁴ (hereinafter referred to as “Acrylic Polymer 1”) was prepared by carrying out solution polymerization, according to a common procedure, of 93 parts by weight of butyl acrylate, 7 parts by weight of acrylic acid, and 0.05 part by weight of 4-hydroxybutyl acrylate in ethyl acetate as a solvent in the presence of 0.1 part by weight of azobisisobutyronitrile as an initiator. This solution was combined with an isocyanate crosslinking agent (supplied by Nippon Polyurethane Industry Co., Ltd. under the trade name of “Coronate L”; a tolylene diisocyanate adduct of trimethylolpropane, with a solids concentration of 75 percent by weight) in an amount of 0.4 part by weight (in terms of solids content), relative to 100 parts by weight of the acrylic polymer, to give a solution of pressure-sensitive adhesive (solution of acrylic pressure-sensitive adhesive).

The prepared solution of pressure-sensitive adhesive was applied to both sides of a poly(ethylene terephthalate) film (supplied by Toray Industries, Inc. under the trade name of “Lumirror S-10”, 12 μm thick), dried at 120° C. for 3 minutes to form pressure-sensitive adhesive layers, and thereby yielded a pressure-sensitive adhesive unit having a thickness from the surface of one of the pressure-sensitive adhesive layers to the surface of the other pressure-sensitive adhesive layer of 50 μm. Each of the two pressure-sensitive adhesive layers had a thickness of 19 μm. The gel fraction of the pressure-sensitive adhesive layers is as in Table 1. In this connection, the two pressure-sensitive adhesive layers have an identical gel fraction.

An anchor coating agent (primer) solution was prepared by adding 7 parts by weight of a curing accelerator (supplied by Toyo-Morton, Ltd. under the trade name of “CAT HY-91”) to 100 parts by weight of an ester-urethane anchor coating agent (supplied by Toyo-Morton, Ltd. under the trade name of “AD-527”), and diluting the mixture with ethyl acetate to have a solids concentration of 5 percent by weight. This anchor coating agent solution was applied, with a roll coater, to a poly(ethylene terephthalate) film (supplied by Toray Industries, Inc. under the trade name of “Lumirror S-105-50”, 50 μm thick) to a thickness of about 1 μm (so as to have a thickness after drying of 0.1 μm), and dried at 80° C. to give an anchor coat layer. A low-density polyethylene (supplied by Asahi Kasei Corporation under the trade name of “L-1850A”) was extruded and laminated onto the anchor coat layer through a tandem process at a temperature below the die of 325° C., to give an under coating layer 10 μm thick. Additionally, a resin composition (as components of a release layer) was prepared by mixing 100 parts by weight of a resin mixture (supplied by Idemitsu Petrochemical Co., Ltd. under the trade name of “MORETEC 0628D”) mainly containing a linear low-density polyethylene with 150 parts by weight of an ethylene-propylene copolymer (supplied by Mitsui Chemicals, Inc. under the trade name of “TAFMER P0180”). The resin composition was extruded and laminated onto the under coating layer at a temperature below the die of 273° C. to give a release layer 10 μm thick, and the release layer was further subjected to microscopic roughening on its surface with an embossed cooling mat roller as a cooling roller, to give a release layer having a roughened surface (release layer with a rough surface). Thus, a release liner (release liner “a”; with a total thickness of about 70 μm) was prepared. In the rough surface of the release layer, embossed or roughened portions with irregularly different shapes were arranged in an irregular positional relationship. The release layer with a rough surface had an arithmetical mean surface roughness (Ra) of 1.5 μm and a maximum surface roughness amplitude of 4 μm.

The product “MORETEC 0628D” is now available from Prime Polymer Co., Ltd. under the trade name of “MORETEC 0628D”.

Additionally, another release liner (release liner “b”; with a total thickness of about 70 μm) was prepared in the following manner. An anchor coating agent (primer) solution was prepared by adding 7 parts by weight of a curing accelerator (supplied by Toyo-Morton, Ltd. under the trade name of “CAT HY-91”) to 100 parts by weight of an ester-urethane anchor coating agent (supplied by Toyo-Morton, Ltd. under the trade name of “AD-527”), and diluting the mixture with ethyl acetate to have a solids concentration of 5 percent by weight. This anchor coating agent solution was applied, with a roll coater, to a polyethylene terephthalate) film (supplied by Toray Industries, Inc. under the trade name of “Lumirror S-105-50”, 50 μm thick) to a thickness of about 1 μm (so as to have a thickness after drying of 0.1 μm), and dried at 80° C. to give an anchor coat layer. A low-density polyethylene (supplied by Asahi Kasei Corporation under the trade name of “L-1850A”) was extruded and laminated onto the anchor coat layer through a tandem process at a temperature below the die of 325° C., to give an under coating layer 10 μm thick. Additionally, a resin composition (as components of a release layer) was prepared by mixing 100 parts by weight of a resin mixture (supplied by Idemitsu Petrochemical Co., Ltd. under the trade name of “MORETEC 0628D”) mainly containing a linear low-density polyethylene with 10 parts by weight of an ethylene-propylene copolymer (supplied by Mitsui Chemicals, Inc. under the trade name of “TAFMER P0180”). The resin composition was extruded and laminated onto the under coating layer at a temperature below the die of 273° C. to give a release layer 10 μm thick to give the release liner (release liner “b”; with a total thickness of about 70 μm).

Then, the release liner “a” (more peelable side) was affixed to one of the adhesive faces of the pressure-sensitive adhesive unit, and the release liner “b” (less peelable side) was affixed to the other adhesive face, so that the releasable layer (release layer) came in contact with the adhesive face, to give a double-coated pressure-sensitive adhesive sheet.

### Example 2

A double-coated pressure-sensitive adhesive sheet was prepared by the procedure of Example 1, except for using the isocyanate crosslinking agent in another amount as in Table and further using a polyfunctional epoxy crosslinking agent (supplied by Mitsubishi Gas Chemical Company, Inc. under the trade name of “TETRAD-C”) as a crosslinking agent.

In Table 1, the “Amount (parts by weight)” of the isocyanate crosslinking agent (Coronate L) represents the “amount as solids content (parts by weight) of Coronate L to 100 parts by weight of the acrylic polymer”. The “Amount (parts by weight)” of the epoxy crosslinking agent (TETRAD-C) represents the “amount (parts by weight) of TETRAD-C itself (as the entire product) to 100 parts by weight of the acrylic polymer.

### Example 3

A double-coated pressure-sensitive adhesive sheet was prepared by the procedure of Example 1, except for using the crosslinking agent in another amount as in Table 1.

### Example 4

A double-coated pressure-sensitive adhesive sheet was prepared by the procedure of Example 1, except for using the crosslinking agent in another amount as in Table 1.

### Example 5

A double-coated pressure-sensitive adhesive sheet was prepared by the procedure of Example 1, except for using the crosslinking agent in another amount as in Table 1.

### Examples 6 to 8

A series of double-coated pressure-sensitive adhesive sheets was prepared by the procedure of Example 2, except for varying the thickness of the poly(ethylene terephthalate) film used as a plastic film base and the thicknesses of the pressure-sensitive adhesive layers as in Table 1.

### Comparative Example 1

A solution (solids concentration of 20 percent by weight) of an acrylic polymer having a weight-average molecular weight of 100×10⁴ (hereinafter referred to as “Acrylic Polymer 2”) was prepared by carrying out solution polymerization, according to a common procedure, of 90 parts by weight of 2-ethylhexyl acrylate and 10 parts by weight of acrylic acid in ethyl acetate as a solvent in the presence of 0.5 part by weight of benzoyl peroxide as an initiator.

A double-coated pressure-sensitive adhesive sheet was prepared by the procedure of Example 1, except for using Acrylic Polymer 2 as the acrylic polymer and varying the conditions such as the amount of the crosslinking agent as in Table 1.

### Comparative Example 2

A solution (solids concentration of 20 percent by weight) of an acrylic polymer having a weight-average molecular weight of 100×10⁴ (Acrylic Polymer 2) was prepared by the procedure of Comparative Example 1, by carrying out solution polymerization, according to a common procedure, of 90 parts by weight of 2-ethylhexyl acrylate and 10 parts by weight of acrylic acid in ethyl acetate as a solvent in the presence of 0.5 part by weight of benzoyl peroxide as an initiator. An isocyanate crosslinking agent (supplied by Nippon Polyurethane Industry Co., Ltd. under the trade name of “Coronate L”) was added to the solution in an amount of 2 parts by weight (in terms of solids content) to 100 parts by weight of the acrylic polymer, to yield a solution of pressure-sensitive adhesive (solution of acrylic pressure-sensitive adhesive).

A release liner used was a release liner including a glassine paper and, arranged on its surface, a releasable layer composed of a silicone release agent (release liner “c”).

A base-less pressure-sensitive adhesive sheet was prepared without using plastic film base as in Table 1, in which the release liner “c” was arranged on or above both sides of the pressure-sensitive adhesive layer. Specifically, the above-prepared solution of pressure-sensitive adhesive was applied to the releasable surface of the release liner “c”, dried at 120° C. for 3 minutes, and thereby yielded a pressure-sensitive adhesive layer 50 μm thick. This release liner would constitute a less peelable side. Thereafter, another release liner “c” (more peelable side) was applied to the other adhesive face opposite to the former release liner “c” so that the releasable layer came in contact with the adhesive face, and thereby yielded a double-coated pressure-sensitive adhesive sheet.

### (Evaluation)

The double-coated pressure-sensitive adhesive sheets prepared according to Examples and Comparative Examples were subjected to measurements or determinations according to following techniques. The results in measurements or determinations are shown in Table 1.

### (1) Outgassing

The release liner of the more peelable side was removed from each of the double-coated pressure-sensitive adhesive sheets prepared according to Examples and Comparative Examples, and a PET film was affixed to the exposed adhesive face. The double-coated pressure-sensitive adhesive sheet bearing the PET film affixed on one side thereof was cut into a piece 1 cm wide and 7 cm long, from which the release liner of the less peelable side was removed, to give a test specimen.

The test specimen was heated at 120° C. for 10 minutes in a purge and trap headspace sampler, the evolved gas was trapped, and the trapped components were analyzed by gas chromatograph/mass spectrometer. The amount of evolved gas (outgassing) was converted in terms of n-decane, and the outgassing was calculated as the amount of outgas per unit area (in unit of μg/cm²).

(2) Adhesive Strength (180-Degree Peel, with Respect to Stainless Steel SUS 304BA)

A strip specimen 20 mm wide and 150 mm long was prepared from each of the double-coated pressure-sensitive adhesive sheets prepared according to Examples and Comparative Examples.

The specimen was subjected to a 180-degree peel test using a tensile tester according to the method specified in Japanese Industrial Standards (JIS) Z0237 to measure a 180-degree peel strength (N/20 mm) from a test plate (SUS 304BA steel plate), and the measured 180-degree peel strength was defined as the “adhesive strength”.

The affixation of the test plate and the specimen was conducted in the following manner: the release liner of the more peelable side was removed from each of the prepared double-coated pressure-sensitive adhesive sheets; a PET film 25 μm thick was affixed (lined) to the exposed surface; the other release liner of the less peelable side was then removed; the exposed surface was overlaid on the test plate; and a 2-kg rubber roller (about 45 mm wide) was placed thereon and moved in one reciprocating manner.

The measurement was conducted under conditions in an atmosphere of 23° C. and 50% at a peel angle of 180 degrees and a rate of pulling of 300 mm per minute, and an adhesive strength was calculated. The test was conducted three times per sample, and the average of measurements was defined as the adhesive strength.

### (3) Release Force of Release Liner

A strip sheet piece 50 mm wide and 150 mm long was cut from each of the double-coated pressure-sensitive adhesive sheets prepared according to Examples and Comparative Examples and used as a test specimen for the measurement of a release force of the more peelable side. For the measurement of a release force of the less peelable side, the release liner of the more peelable side was removed, and a PET film 25 μm thick was affixed (lined) to the exposed surface, to give a test specimen.

Each of the test specimens was subjected to a 180-degree peel test using a tensile tester according to the method specified in JIS Z0237 to measure a 180-degree peel strength (N/50 mm) of each release liner, and the measured 180-degree peel strength was defined as a “release force of release liner”.

The measurement was conducted under conditions in an atmosphere of 23° C. and 50% at a peel angle of 180 degrees and a rate of pulling of 300 mm per minute, and an adhesive strength was calculated. The test was conducted three times per sample, and the average of measurements was defined as the release force.

Tests were conducted on both the release liners of the less peelable side and of the more peelable side. In the measurement of a release force of the release liner of the less peelable side, the adhesive face on which the release liner of the more peelable side had been arranged was lined (backed) with a PET film, as described above.

### (4) Lifting (at 70° C. for 2 Hours)

A test specimen was prepared by affixing an adhesive face of one side (more peelable side) of each of the double-coated pressure-sensitive adhesive sheets prepared according to Examples and Comparative Examples (size: 10 mm wide and 90 mm long) to an aluminum sheet 0.5 mm thick, 10 mm wide, and 90 mm long. The test specimen was bent into an arcuate shape along a round rod of 50 mm in diameter so that the pressure-sensitive adhesive sheet faced outward; the release liner of the less peelable side was removed from the test specimen to expose the pressure-sensitive adhesive layer; and the exposed pressure-sensitive adhesive layer was affixed to an adherend through compression bonding using a laminator. The adherend was a sheet prepared by affixing a polyimide film “Kapton 100H” to a polypropylene (PP) sheet 2 mm thick through a pressure-sensitive adhesive tape. The pressure-sensitive adhesive layer was affixed to the polyimide film of the adherend. The resulting article was left stand in an environment of 23° C. for 24 hours, heated at 70° C. for 2 hours, and the height (mm) of an end of the test specimen lifted or raised from the adherend surface was measured and defined as “lifting” (mm). The lifting herein is the average of lifted heights of both ends of the test specimen.

In this connection, a double-coated pressure-sensitive adhesive sheet, if used for a component which will be heated after affixation of the sheet, preferably has a lifting of smaller than 1.5 mm.

### (5) Processing Suitability Test

A specimen for workability evaluation was prepared by half-cutting each of the double-coated pressure-sensitive adhesive sheets prepared according to Examples and Comparative Examples from the release liner “b” using a pressing machine, in which only the release liner “b” and the pressure-sensitive adhesive unit were notched. The specimen for workability evaluation was left in an atmosphere at a temperature of 60° C. and relative humidity of 90% for one week, and whether or not an autohesion of the cut surfaces occurred was observed, and the workability (processing suitability) was evaluated according to the criteria mentioned below.

Regarding Comparative Example 2, the double-coated pressure-sensitive adhesive sheet was half-cut from the release liner of the less peelable side, and evaluation was conducted in the same manner as above.

Criteria for Processing Suitability

Good: No autohesion was observed at the cut surfaces.
Poor: Autohesion was observed at the cut surfaces.

### (6) Followability to Difference in Level

The release liner of the more peelable side was removed from each of the double-coated pressure-sensitive adhesive sheets (prepared according to Examples and Comparative Examples, size: 40 mm wide and 40 mm long) to expose an adhesive face, and the exposed adhesive face was applied to a surface of the film base layer of a FPC mentioned below through compression bonding under conditions at a temperature of 60° C. and a pressure of 2 MPa for 10 seconds. After compression bonding, the article was observed from the double-coated pressure-sensitive adhesive sheet side with a microscope of a magnification of 50 times. A sample showing little “adhesion failure (lifting)” between the double-coated pressure-sensitive adhesive sheet and the film base layer typically in a portion with difference in level was evaluated as having good followability to difference in level; and one showing much “adhesion failure” was evaluated as having poor followability to difference in level.

### [FPC (Adherend)]

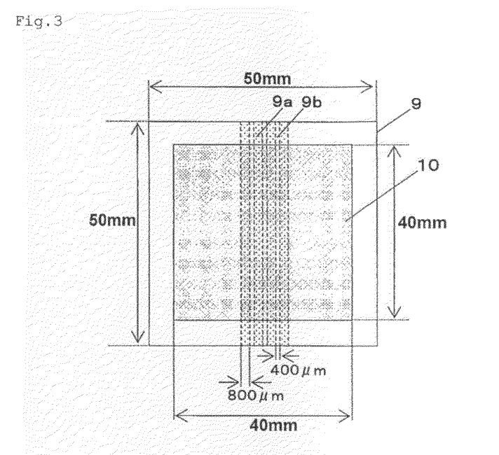

FIG. 2 is an explanatory drawing (schematic cross-sectional view) illustrating a multilayer structure of the FPC used as the adherend above. FIG. 3 is an explanatory drawing (plan view when viewed from the film base layer side) illustrating how and where the double-coated pressure-sensitive adhesive sheet (test specimen) was affixed to the FPC.

The FPC structurally includes a base dielectric layer; a copper foil layer (conductor layer) 6 arranged on the base dielectric layer; and a covering dielectric layer arranged on the copper foil layer 6. The base dielectric layer has a multilayer structure including a polyimide film base layer 4 and an epoxy adhesive layer 5. The covering dielectric layer has a multilayer structure including a polyimide cover lay film layer 8 and an epoxy adhesive layer 7. The film base layer 4 has a thickness of 0.025 mm, the adhesive layer 5 has a thickness of 0.015 mm, the copper foil layer 6 has a thickness of 0.035 mm, the cover lay adhesive layer 7 has a thickness of 0.025 mm, and the cover lay film layer 8 has a thickness of 0.025 mm.

The copper foil layer is formed so as to have four linear circuit traces each having a width of the copper foil (line width) of 800 μm and a width of a space between adjacent copper foils of 400 μm. The surface of the film base layer of the FPC has difference in level (steps) caused by the copper foil lines and spaces between the copper foil lines in the copper foil layer.

The double-coated pressure-sensitive adhesive sheet (test specimen) 10 was affixed to the surface of the film base layer of the FPC (adherend) 9 as illustrated in FIG. 3. In FIG. 3, “9a” stands for a portion where the copper foil is arranged, and “9b” stands for a portion where the copper foil is not arranged.

TABLE 1

| | | | | | | | | | | Com. | Com. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| Plastic film base (thickness) | | PET film | PET film | PET film | PET film | PET film | PET film | PET film | PET film | PET film | without |
| | | (12 μm) | (12 μm) | (12 μm) | (12 μm) | (12 μm) | (16 μm) | (9 μm) | (4 μm) | (12 μm) | base |
| Pressure- | Acrylic polymer | Acrylic | Acrylic | Acrylic | Acrylic | Acrylic | Acrylic | Acrylic | Acrylic | Acrylic | Acrylic |
| sensitive | | Polymer 1 | Polymer 1 | Polymer 1 | Polymer 1 | Polymer 1 | Polymer 1 | Polymer 1 | Polymer 1 | Polymer 2 | Polymer 2 |
| adhesive | Amount (part by | 0 | 0.01 | 0 | 0 | 0 | 0.01 | 0.01 | 0.01 | 0 | 0 |
| layer | weight) of epoxy | | | | | | | | | | |
| | crosslinking agent | | | | | | | | | | |
| | Amount (part | 0.4 | 0.2 | 0.3 | 2 | 0.1 | 0.2 | 0.2 | 0.2 | 1 | 2 |
| | by weight) of | | | | | | | | | | |
| | isocyanate | | | | | | | | | | |
| | crosslinking agent | | | | | | | | | | |
| | Thickness of | 19 | 19 | 19 | 19 | 19 | 17 | 20.5 | 23 | 19 | — |
| | pressure-sensitive | | | | | | | | | | |
| | adhesive layer | | | | | | | | | | |
| | (one layer) (μm) | | | | | | | | | | |
| Thickness of pressure- | | 50 | 50 | 50 | 50 | 50 | 50 | 50 | 50 | 50 | 50 |
| sensitive adhesive | | | | | | | | | | | |
| unit (μm) | | | | | | | | | | | |
| Release liner | | non- | non- | non- | non- | non- | non- | non- | non- | non- | silicone |
| | | silicone | silicone | silicone | silicone | silicone | silicone | silicone | silicone | silicone | both- |
| | | both- | both- | both- | both- | both- | both- | both- | both- | both- | sided |
| | | sided | sided | sided | sided | sided | sided | sided | sided | sided | |
| Gel fraction of pressure- | | 18 | 40 | 18 | 85 | 0 | 40 | 40 | 40 | 38 | 70 |
| sensitive adhesive | | | | | | | | | | | |
| layer (%) | | | | | | | | | | | |
| Outgassing (μg/cm²) | | 0.18 | 0.17 | 0.2 | 0.4 | 0.2 | 0.15 | 0.5 | 0.6 | 2.3 | 15 |
| Adhesive strength (N/20 mm) | | 8.7 | 9.0 | 7.9 | 7.0 | 8.4 | 6.0 | 10.0 | 10.0 | 8.2 | 8.6 |
| (180-degree peel, to | | | | | | | | | | | |
| SUS 304BA steel sheet) | | | | | | | | | | | |
| Release | More peelable | 0.18 | 0.16 | 0.2 | 0.08 | 0.2 | 0.15 | 0.2 | 0.2 | 0.29 | 0.1 |
| force of | side (N/50 mm)) | | | | | | | | | | |
| release | Less peelable | 0.85 | 0.93 | 0.9 | 0.8 | 0.9 | 0.8 | 1 | 1 | 0.66 | 0.3 |
| liner | side (N/50 mm) | | | | | | | | | | |

| | | | | | | | | | | |
|---|---|---|---|---|---|---|---|---|---|---|
| Lifting (mm) at 70° C. | 0.5 | 0.5 | 0.9 | 1.8 | 10.3 | 1.2 | 0.5 | 0.5 | 0.6 | 1.3 |
| for 2 hours | | | | | | | | | | |
| Processing suitability | Good | Good | Good | Good | Good | Good | Good | Good | Good | Poor |
| Followability to | Good | Good | Good | Good | Good | Poor | Good | Good | Good | Good |
| difference in level | | | | | | | | | | |

Acrylic Polymer 1: Butyl acrylate (93 parts by weight)/acrylic acid (7 parts by weight)/hydroxybutyl acrylate (0.05 part by weight), with azobisisobutyronitrile as an initiator
Acrylic Polymer 2: 2-Ethylhexyl acrylate (90 parts by weight)/acrylic acid (10 parts by weight) with benzoyl peroxide as an initiator
Epoxy crosslinking agent: trade name “TETRAD-C” supplied by Mitsubishi Gas Chemical Company, Inc.
Isocyanate crosslinking agent: trade name “Coronate L” supplied by Nippon Polyurethane Industry Co., Ltd.

The evaluation results (Table 1) demonstrate that double-coated pressure-sensitive adhesive sheets according to the present invention (Examples 1 to 8) evolve small amounts of outgas, show good processing suitability, and are advantageously usable as double-coated pressure-sensitive adhesive sheets adopted to fix hard disk drive components.

Among them, double-coated pressure-sensitive adhesive sheets whose pressure-sensitive adhesive layer has a gel fraction of from 10% to 60% (Examples 1 to 3 and 6 to 8) are resistant to “lifting” even after storage at elevated temperatures over a long period of time and are advantageously usable in applications in which the resulting article undergoes a heating process. In contrast, a pressure-sensitive adhesive sheet having a gel fraction in the pressure-sensitive adhesive layer of greater than 60% (Example 4) has an excessively high repulsive force; and one having a gel fraction of smaller than 10% (Example 5) is susceptible to a cohesive failure of the pressure-sensitive adhesive layer, is likely to suffer from “lifting” of the pressure-sensitive adhesive layer, and is inferior in characteristic properties for use in applications in which the resulting article undergoes a temperature-elevating or heating process.

The results further demonstrate that double-coated pressure-sensitive adhesive sheets whose plastic film base has a thickness of 13 μm or less (Examples 1 to 5, 7, and 8) show superior followability to difference in level and are advantageously usable even to finely patterned adherends upon affixation with a low pressing force. In contrast, a double-coated pressure-sensitive adhesive sheet whose plastic film base has a thickness of greater than 13 μm (Example 6) is inferior in followability to difference in level and is inferior in characteristic properties as used for applications where the adhesive sheet is affixed to a finely patterned adherend with a low pressing force.

In contrast, a base-less pressure-sensitive adhesive sheet using no plastic film base (Comparative Example 2) does not show satisfactory processing suitability.

### INDUSTRIAL APPLICABILITY

Double-coated pressure-sensitive adhesive sheets adopted to fix a hard disk drive component, according to the present invention, have good workability and, in addition, cause less contamination and less outgassing. When further specified in the thickness of the plastic film base, they are also superior in followability to difference in level. When further specified in the gel fraction of the pressure-sensitive adhesive layer within a specific range, they are resistant to “lifting” from an adherend even when subjected to a heating process after affixation to the adherend. The double-coated pressure-sensitive adhesive sheets according to the present invention are thereby useful as double-coated pressure-sensitive adhesive sheets adopted to fix components, such as flexible printed circuit boards, upon fabrication of hard disk drives. In addition, hard disk drives fabricated using the double-coated pressure-sensitive adhesive sheets do not suffer from contamination derived from the pressure-sensitive adhesive sheets and lifting of the flexible printed circuit board and thereby have superior reliability with high quality, thus being useful.

1. A double-coated pressure-sensitive adhesive sheet adopted to fix a hard disk drive component, the adhesive sheet comprising a pressure-sensitive adhesive unit including a plastic film base having a thickness of 20 μM or less and pressure-sensitive adhesive layers arranged on or above both sides of the plastic film base; and non-silicone release liners arranged on both surfaces of the pressure-sensitive adhesive unit, wherein the pressure-sensitive adhesive unit has a thickness of 60 μm or less, and wherein the double-coated pressure-sensitive adhesive sheet shows an outgassing of 1 μg/cm² or less when the double-coated pressure-sensitive adhesive sheet is heated at a temperature of 120° C. for 10 minutes.

2. The double-coated pressure-sensitive adhesive sheet adopted to fix a hard disk drive component, according to claim 1, wherein the plastic film base has a thickness of 13 μm or less.

3. The double-coated pressure-sensitive adhesive sheet adopted to fix a hard disk drive component, according to claim 1, wherein the pressure-sensitive adhesive layers each have a gel fraction of 10% to 60%.

4. The double-coated pressure-sensitive adhesive sheet adopted to fix a hard disk drive component, according to claim 1, wherein the pressure-sensitive adhesive layers each comprise an acrylic pressure-sensitive adhesive including an acrylic polymer and a crosslinking agent and containing substantially no tackifier resin.

5. The double-coated pressure-sensitive adhesive sheet adopted to fix a hard disk drive component, according to claim 4, wherein the acrylic pressure-sensitive adhesive comprises 100 parts by weight of an acrylic polymer; 0.15 to 1 part by weight of an isocyanate crosslinking agent; and 0 to 0.05 part by weight of an epoxy crosslinking agent.

6. The double-coated pressure-sensitive adhesive sheet adopted to fix a hard disk drive component, according to claim 1, wherein the non-silicone release liners are polyolefin release liners.

7. The double-coated pressure-sensitive adhesive sheet adopted to fix a hard disk drive component, according to claim 1, wherein the hard disk drive component is a flexible printed circuit board.

8. A hard disk drive comprising a component as fixed using the double-coated pressure-sensitive adhesive sheet of claim 1.

9. The double-coated pressure-sensitive adhesive sheet adopted to fix a hard disk drive component, according to claim 2, wherein the pressure-sensitive adhesive layers each have a gel fraction of 10% to 60%.

10. The double-coated pressure-sensitive adhesive sheet adopted to fix a hard disk drive component, according to claim 2, wherein the pressure-sensitive adhesive layers each comprise an acrylic pressure-sensitive adhesive including an acrylic polymer and a crosslinking agent and containing substantially no tackifier resin.

11. The double-coated pressure-sensitive adhesive sheet adopted to fix a hard disk drive component, according to claim 3, wherein the pressure-sensitive adhesive layers each comprise an acrylic pressure-sensitive adhesive including an acrylic polymer and a crosslinking agent and containing substantially no tackifier resin.

12. The double-coated pressure-sensitive adhesive sheet adopted to fix a hard disk drive component, according to claim 9, wherein the pressure-sensitive adhesive layers each comprise an acrylic pressure-sensitive adhesive including an acrylic polymer and a crosslinking agent and containing substantially no tackifier resin.

13. The double-coated pressure-sensitive adhesive sheet adopted to fix a hard disk drive component, according to claim 10, wherein the acrylic pressure-sensitive adhesive comprises 100 parts by weight of an acrylic polymer; 0.15 to 1 part by weight of an isocyanate crosslinking agent; and 0 to 0.05 part by weight of an epoxy crosslinking agent.

14. The double-coated pressure-sensitive adhesive sheet adopted to fix a hard disk drive component, according to claim 11, wherein the acrylic pressure-sensitive adhesive comprises 100 parts by weight of an acrylic polymer; 0.15 to 1 part by weight of an isocyanate crosslinking agent; and 0 to 0.05 part by weight of an epoxy crosslinking agent.

15. The double-coated pressure-sensitive adhesive sheet adopted to fix a hard disk drive component, according to claim 2, wherein the non-silicone release liners are polyolefin release liners.

16. The double-coated pressure-sensitive adhesive sheet adopted to fix a hard disk drive component, according to claim 3, wherein the non-silicone release liners are polyolefin release liners.

17. The double-coated pressure-sensitive adhesive sheet adopted to fix a hard disk drive component, according to claim 2, wherein the hard disk drive component is a flexible printed circuit board.

18. The double-coated pressure-sensitive adhesive sheet adopted to fix a hard disk drive component, according to claim 3, wherein the hard disk drive component is a flexible printed circuit board.

19. A hard disk drive comprising a component as fixed using the double-coated pressure-sensitive adhesive sheet of claim 2.

20. A hard disk drive comprising a component as fixed using the double-coated pressure-sensitive adhesive sheet of claim 3.
